(19) United States
(12) Patent Application Publication
(10) Pub. No.: US 2013/0200007 A1
(43) Pub. Date: Aug. 8, 2013

(54) LIQUID RECLAMATION SYSTEMS AND METHODS

(71) Applicant: O3 Industries, LLC, Saint Cloud, MN (US)

(72) Inventors: Michael T. O'KONEK, South Haven, MN (US); Dusten C. O'KONEK, JR., Annandale, MN (US); Dusten C. O'KONEK, SR., South Haven, MN (US)

(73) Assignee: O3 INDUSTRIES, LLC, Saint Cloud, MN (US)

(21) Appl. No.: 13/833,806

(22) Filed: Mar. 15, 2013

Related U.S. Application Data
(63) Continuation-in-part of application No. 13/588,459, filed on Aug. 17, 2012.
(60) Provisional application No. 61/525,042, filed on Aug. 18, 2011.

(51) Int. Cl. C02F 9/00

(52) U.S. Cl. CPC C02F 9/00
USPC 210/749; 210/241; 210/257.1; 210/205; 210/151; 210/787; 494/43; 494/37

(57) ABSTRACT

A liquid recovery system and methods of recycling water from liquid-solid mixture such as slurry produced by pavement grinding machines, drilling fluid containing cuttings, and septage. The system includes a storage tank or a settling tank, a centrifuge in flow communication with the storage tank or settling tank, such as a hydraulic centrifuge, a solids storage component, and a cleaned liquid storage tank in flow communication with the centrifuge. The system may also include a porous conveyor belt for removal of large solids from the mixture prior to centrifugation and may also include one or more blowers directed at the porous conveyor.

### PRIORITY

This application claims priority to U.S. Provisional Patent Application No. 61/525,042, filed Aug. 18, 2011 and entitled WATER RECLAMATION SYSTEM and U.S. patent application Ser. No. 13/588,459 filed Aug. 17, 2012, entitled WATER RECLAMATION SYSTEMS AND METHODS, the disclosures of which are hereby incorporated by reference.

### BACKGROUND

Systems such as pavement grinders, septic systems, and drilling systems such as oil drilling systems, use large volumes of water and other fluids with solid matter included in or suspended in the fluids. In many such uses, it may be desirable to separate the fluid from the solids for purposes such as reuse of the fluid, recovery of the solids, safe disposal of the fluid or solids, or disposal with reduced environmental impact, and improved efficiency, but such separation systems may be inadequate.

For example, pavement grinders are used for grinding paved surfaces such as roadways. Such grinding may be done to prepare the surface for resurfacing or to texture the surface to improve traction or water drainage. During the grinding process, water is typically sprayed directly onto the grinder blades for cooling and lubrication. A slurry is formed which includes chunks of pavement of various sizes as well as particles of pavement suspended in the water. The grinders suck up the slurry and transfer it to a tanker at an off-site plant or into a holding pond for transportation and later treatment. In some cases, depending upon local laws, the slurry is pumped directly into a roadside ditch. In this way, pavement grinders consume large quantities of water. While the grinders have water tanks which are filled at the start of operations, because so much water is used, these tanks are not sufficient to allow the grinders to operate continuously without periodically being refilled by a tanker truck that travels to the worksite to refill the grinders' water tanks

In addition to periodic tanker trips to the worksite to refill water tanks, the tanker that holds the slurry must also periodically unload the slurry. Systems for separating the water from the particulate components are known, but such systems have various drawbacks and are not ideal for mobile use.

In addition, due to the composition of concrete pavement, which may include portland cement, sand, fly ash, and various aggregates, the slurry is typically highly basic. Exhaust pollution deposited on the road surface also contributes to the composition of the slurry and makes it more basic. As such, it is preferable not to dispose of the slurry, or the water contained in the slurry, into the environment without adjusting the pH, and in some regions pH adjustment is legally required.

Fluids used in drilling into the earth, such as drilling for oil and gas, are referred to as drilling fluids or drilling muds. Such fluids are used in the borehole to lubricate, clean and cool the drill bit, control pressure, and to suspend and carry the material being drilled (the cuttings) to the surface. Drilling fluid may be water-based, oil-based (invert mud), or synthetic-based (using a fluid such as a synthetic oil), for example. A myriad of other components may also be included in the drilling fluid to adjust its properties. The drilling fluid may flow through the drill pipe, out of the drill bit, and into the bore hole. The drilling fluid is then flushed back up the bore hole to the surface, where it may be discharged into the surrounding environment or may be cleaned and recirculated. This cleaning may include pumping the drilling fluid onto a vibrating screen. Solid components may be separated by being held by the screen, while the fluid, and potentially small solid components having a size less than that of the screen, pass through to a storage area (mud pit) until pumped back into the drill.

Septic tanks store waste water, such as the water from toilets and sinks produced by a home. The waste water includes solid matter that is digested by bacteria within the tank, and the liquid component (effluent) is discharged into a drain field once it is sufficiently clean. However, some solid components remain undigested and accumulate within the tank, such that the tank must be periodically pumped out to maintain normal functioning. The material pumped out of the tank, referred to septage, may be transferred to a waste treatment facility, for example.

### SUMMARY

Embodiments include mobile liquid recovery systems which may be used for separating liquids from solids included in various liquid-solid mixtures. The system can include a platform having a plurality of wheels, a mixture storage tank, a centrifuge in flow communication with the mixture storage tank, a solids storage compartment, and a cleaned liquid storage tank in flow communication with the centrifuge. In some embodiments, the system also includes a sieve and the mixture first passes through the sieve and then passes into the centrifuge. In some embodiments, the system includes a liquid permeable conveyor and one or more air knives directing air toward the conveyor and such that the mixture first passes through the permeable conveyor and then into the liquid-solid mixture tank and then into centrifuge. In some embodiments, the system may use a mixture settling tank in place of, or in addition to, the mixture storage tank and permeable conveyor or sieve. In some embodiments, the system also includes an acidifier, which can be located within the cleaned liquid storage tank, for example.

In some embodiments, the acidifier is located in a cleaned liquid storage tank and acidifies the recovered liquid by bubbling engine exhaust through the cleaned liquid.

In some embodiments, the centrifuge is a hydraulic centrifuge.

In other embodiments, the mobile water recovery system includes a platform having a plurality of wheels, a mixture storage tank, a centrifuge in flow communication with the mixture storage tank, a solids storage component, a cleaned liquid storage tank in flow communication with the centrifuge, an engine which produces exhaust, and an exhaust bubbler within the cleaned liquid storage tank. The exhaust bubbler can be configured to receive the exhaust from the engine and release the exhaust through a plurality of apertures in the exhaust bubbler when the cleaned liquid storage tank contains cleaned liquid. The bubbles produced by the exhaust bubbler can be sufficient to reduce the pH of the cleaned water to less than about 10, for example.

In some embodiments, the exhaust bubbler includes an exhaust inlet and a bubbler plate which is a horizontally oriented with the plurality of apertures located on the upper surface of the plate.

In some embodiments, the system also includes a blower located in exhaust flow communication between an exhaust outlet of the engine and the exhaust bubbler. The system may also include an exhaust cleaning unit in flow communication between the engine exhaust outlet and the exhaust bubbler to reduce the amount of hydrocarbons in the exhaust.

Other embodiments include methods of recycling liquid from liquid-solid mixtures produced by systems such as pavement grinders, oil and gas drills, and septic systems. The method may include the steps of pumping the mixture into a mixture storage tank, centrifuging the mixture to separate a solid component from a cleaned liquid component, transmitting the cleaned liquid component from the centrifuge to a cleaned liquid tank, and transmitting the solid component to a solids storage component. The mixture storage tank, the centrifuge, the cleaned liquid tank, and the solids storage component can each be components of a mobile liquid reclamation system, and the method can further include towing the mobile liquid system behind a machine such as a pavement grinder.

In some embodiments, the method also includes reducing the pH of the cleaned liquid within the cleaned water tank. For example, the liquid reclamation system may also include an engine which produces exhaust, and reducing the pH of the cleaned liquid may include bubbling the exhaust through the cleaned liquid. In some embodiments, the method also includes reducing the amount of hydrocarbons present in the exhaust prior to bubbling the exhaust through the cleaned liquid. In some embodiments, the pH of the liquid or the liquid-solid mixture may be performed by a stand-alone device or a device which is part of a different system, such as a pavement grinding vehicle, without the separation of the liquid-solid mixture.

In some embodiments, the method includes passing the mixture through a sieve prior to centrifuging the mixture. In some embodiments, the method includes passing the mixture through a permeable conveyor belt with blowers to remove large solids prior to centrifuging the mixture.

### FIGURES

FIG. 1a is a side view of a liquid reclamation system according to embodiments of the invention;

FIG. 1b is a top view of the liquid reclamation system of FIG. 1a;

FIG. 2a is a top view of a liquid reclamation system according to other embodiments of the invention;

FIG. 2b is a side view of the liquid reclamation system of FIG. 2a;

FIG. 3a is a top view of a conveyor system according to embodiments of the invention;

FIG. 3b is a side view of the conveyor system of FIG. 3a;

FIG. 4a is a top view of an exhaust bubbler system according to embodiments of the invention;

FIG. 4b is a side view of the exhaust bubbler system of FIG. 4a;

FIG. 4c is an end view of the exhaust bubbler system of FIGS. 4a and 4b; and

FIG. 5 is a schematic flow chart of a system according to an embodiment of the invention.

### DESCRIPTION

The following detailed description is exemplary in nature and is not intended to limit the scope, applicability, or configuration of the invention in any way. Rather, the following description provides some practical illustrations for implementing examples of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Embodiments of the invention include methods and systems for recovery of liquid and separation of liquid from solid in liquid-solid mixtures produced by various systems such as pavement grinding machines, oil and gas drills, and septic systems. The liquid recovery systems may be mobile, and may be provided as a trailer for attachment directly to a vehicle such as a pavement grinding machine or for attachment to a truck or other vehicle for transportation of the system such as to a location for use, may be self-propelled, or may be stationary. In some embodiments, the methods and systems further include neutralization of the pH of the recovered liquid using vehicle emissions, such as by bubbling engine exhaust through the recovered liquid.

Pavement grinders use a large quantity of water to cool the cutting tools as they grind the pavement. As such, after a pavement grinder passes over a piece of pavement, such as a road, parking lot, or runway, the water is sprayed directly onto the pavement and/or the cutting tools from one or more spray nozzles on the pavement grinder. The pavement grinder then removes the slurry from the roadway or other surface. Similarly oil and gas drills produce large volumes of liquid-solid mixtures in drilling fluids, and septic systems produce large volumes of liquid-solid mixtures. In every case there may be a benefit to efficiently separating the liquid and solid components. Various embodiments herein, therefore, pass the liquid-solid mixture, such as the pavement slurry, drilling fluid and cuttings, or septage, to a liquid recovery system for processing.

Embodiments of the invention process the liquid-solid mixture to separate the liquid from the solid components. The mixture passes through the water recovery system, which may include a mixture storage tank, a slurry strainer and/or permeable conveyor and blower, one or more centrifuges, a dry material storage compartment, and a clean liquid storage tank. The clean liquid, such as water or drilling fluid, that is produced may then be returned to the system such as the pavement grinding machine or drilling system for use in further pavement grinding operations or drilling, or in the case of clean water may be released into the environment. In some embodiments, the clean liquid may be further processed to cool the liquid and/or to neutralize the pH by acidifying the liquid, such as by bubbling engine exhaust through the cleaned liquid.

In some embodiments, the liquid recovery system may be in the form of a wheeled system, such as a trailer, which may attach to the back of a vehicle such as a pavement grinder. In such systems, one or more hoses and cables may connect the vehicle to the liquid recovery system which trails it or otherwise travels adjacent to it, so that liquid recovery, purification, and/or recycling of cleaned liquid to the vehicle, occurs simultaneously with production such as pavement grinding, for example. Alternatively, the liquid recovery system may be self-propelled and may or may not be connected to a vehicle, or it may be stationary.

The liquid-solid mixture produced by pavement grinders is referred to as slurry. The slurry that is produced by pavement grinders includes water with fine particulates which are ground pieces of pavement and can also include pavement chunks and road debris. The pavement grinders typically include a hose and pump to recover the slurry from the ground surface and pump it either onto the roadside or into a storage tank. When the pavement grinder is used with the liquid recovery system according to some embodiments of the invention, the slurry may be pumped directly from the ground and into a liquid storage tank in the liquid recovery system or from the grinder slurry storage tank into the mixture storage tank of the liquid recovery system. This transfer may occur under the control of the hoses and pumps that are typically part of pavement grinders.

The mixture storage tank of the liquid recovery system may include an inlet for receipt of the liquid-solid mixture from a source such as a pavement grinder, drill, or septic system and an outlet. Alternatively, the mixture storage tank may be open on the top and may be filled from above. The storage tank may be any water-tight heavy-duty compartment. It may hold about 1,000 to about 1,500 gallons of liquid-solid mixture, for example, or other amounts depending upon engineering design choices. It may include an agitator to keep the solids such as particulates in suspension, such as a paddle or pumps, located within the tank, to recirculate the liquid in the tank to keep particulates in suspension. In some embodiments, the mixture storage tank may include a sloped bottom with an outlet at the lowest location of the tank.

In some embodiments the liquid storage tank will have a means of adding one or more treatment compositions such as water treatment products that include but are not limited to floculents, polymers, pH control media, antifoaming agents, and demulsifiers, for example. Treatment compositions that are dry may be conveyed into the mixture storage tank via a blower such as a venturi type blower or an auger that has a metering ability. Treatment compositions that are liquid may be conveyed into the storage tank by a pump such as a metering fixed displacement type pump such as, but not limited to, a peristatltic pump, a gear pump, a diaphragm pump, or a piston pump, for example. For certain embodiments, these treatments must be added to the liquid solid mixture to alter the characteristics of the final products (the separated liquids or solids) for either reuse or disposal, or to aid in the separation of the liquid and solid components, for example.

In some embodiments, the slurry may next pass through pipes to an optional slurry strainer. This strainer may be in the form of a sieve, for example. The strainer may be used to remove large roadway debris from the mixture, such as fallen vehicles pieces (such as bolts, hubcaps, tire scraps), garbage (such as beverage containers or plastic bags), or other roadway debris that may be present in pavement slurry. The strainer may also remove large pieces of pavement that may be present in the slurry. In some embodiments, the strainer may remove large cuttings from the drilling fluid or may remove large solid non-degradable items flushed down the toilet from the septage. In some embodiments, the strainer may be sized to exclude items measuring about 1/16 inch or larger, or about ⅛ inch or larger, while in other embodiments it may be sized to exclude items measuring about ¼ inch or about ½ inch or larger.

In some embodiments, the liquid reclamation system includes two strainers and two centrifuges, with separate portions of the mixture passing in parallel through the first strainer to the first centrifuge and through the second strainer to the second centrifuge. In still other embodiments, the water reclamation system may include a third strainer and a third centrifuge, with the mixture passing likewise in parallel to the third strainer and third centrifuge. Alternatively, the mixture may pass through one or more strainers in series and may then pass to a first, second and/or third centrifuge in parallel. For example, the strainers in series, such as two or three strainers, may be sized to separate different sized items, such as increasingly smaller items. Thus it will be understood that the system may include a plurality of strainers and centrifuges. Solid material separated out of the mixture by the strainers may be periodically removed manually or may be periodically expelled by the strainers.

In some embodiments, as an alternative to strainer or in addition to strainers, the liquid reclamation system may include a porous conveyor belt and optionally one or more blowers such as air knives or other high air-flow blowers. The liquid-solid mixture may be pumped onto the generally horizontal porous conveyor belt at a location directly above the mixture storage tank. In this way, liquid-solid mixture may flow through the porous material of the conveyor belt into the mixture storage tank under the force of gravity in the nature of a sieve. However, because it is a conveyor, the solids too large to pass through the porous conveyor material may be excluded and thereby separated out of the mixture, remaining on the top surface of the conveyor. The conveyor belt may continuously convey the excluded solids away such that they are ultimately transferred to the solid material storage tank as the liquid-solid mixture is pumped onto the moving conveyor, such that the porous conveyor does not become clogged or overloaded by solids but rather continues to allow the liquid-solid mixture to pass through it. The conveyor speed may be adjustable to accommodate different rates of input of liquid-solid mixture, as these rates may vary with production rates (such as the rate of slurry production by a pavement grinder).

To aid the porous conveyor in filtering liquid-solid mixture, the system may include one or more air blowers directing air at the porous conveyor. One or more air blowers may be located above the conveyor to direct air onto outer surface of the top portion of the conveyor and/or one or more blowers may be located within the loop of the conveyor belt to direct air onto the inner surface of the bottom portion of the conveyor belt. The air blower(s) directing air onto the top portion of the conveyor (the upper blowers) may push liquid downward, through the large excluded solids and then through the porous conveyor. These blowers may also generally assist in drying out the retained solids.

The air blowers directing air onto the inner surface of the bottom portion of the conveyor belt (the lower blowers) may be displaced from the upper surface blowers such that they are not directly beneath the upper blowers. Rather, the upper blowers may direct air at the conveyor at and/or just after (in the direction of belt movement) or rearward of the location at which the mixture is pumped onto the porous conveyor belt. The lower blowers may direct air at the conveyor at a location more downstream from the upper blowers, at a location to which the conveyor passes after receipt of the mixture and after the upper blowers. The lower blowers may function in assisting the mixture to flow through the porous conveyor belt by blowing air through the pores in the conveyor belt from the inner surface and downward to dislodge any solids that may be trapped in the pores or stuck to the conveyor belt surface. The dislodged solids may be conveyed away with the large excluded solids by falling onto a chute or other conveyor, for example.

The porosity of the conveyor may be selected based upon the type of liquid-solid mixture with which it is used. The pore size selected should be sufficiently large to not impede the flow of the liquid-solid mixture through the pored of the conveyor belt yet small enough to capture any solids that may be large enough to cause damage to the pumps that transfer the mixture to the centrifuges or to the centrifuges themselves. For example, when used with pavement grinding slurry, the pore size (diameter) may be between about 5 Mesh and about 20 Mesh, or between about 100 Mesh and about ¼ inch.

In addition, the material of the conveyor belt should be sufficiently strong to hold the weight of the liquid-solid mixture or of the excluded solids without becoming damaged or without the pores becoming deformed despite being open beneath the belt (the belt being suspended, such as between the two roller ends), while at the same time sufficiently flexible to bend around rollers that power and turn the conveyor belt. Examples of appropriate materials to be used for the porous conveyor belt include monofilament nylon, stainless steel, carbon steel, bronze, aluminum, fiberglass, rubber, or any other material that can produce the required pore size and be compatible with the fluid being processed.

The upper and lower blowers may direct a high speed air flow toward the conveyor belt. In some embodiments, one or more of the blowers may be air knives. For example, in some embodiments, the blowers may blow air at between about 400 and about 2300 standard cubic feet per minute (SCFM), or between about 600 and about 1200 SCFM, in a strip of air extending across the width of the conveyor belt.

In some embodiments, the liquid-solid mixture may enter into a mixture settling tank which may be used in addition to, or in place of, the mixture storage tank. For example, the liquid reclamation system may include a mixture settling tank in place of the mixture storage tank and strainer or porous conveyor and optional blower, and the mixture may pass directly from the source to the mixture settling tank and then to the centrifuge. The mixture settling tank may be in the form of a vertically mounted conical or cylindrical tank which may have a greater height than width. The mixture settling tank may include a debris removal element for removing debris, such as an auger or pump, with may be connected to the bottom of the tank for removing debris from the bottom of the settling tank. The settling tank may be used to remove large debris from the mixture, such as fallen vehicles pieces (such as bolt, hubcaps, tire scraps), garbage (such as beverage containers or plastic bags), or other roadway debris or large pieces of pavement, large cuttings, non-biodegradable flushed items such as sanitary products, rocks, and other items that may be flushed down a toilet such as toys, jewelry, or birth control prophylactics, for example, that may be present in the mixture. For example, in some embodiments, the flow through the settling tank may be adjusted to exclude items measuring about 1/32 inch or larger, or about ⅛ inch or larger, while in other embodiments it may be adjusted to exclude items measuring about ¼ inch or about ½ inch or larger.

In some embodiments, the liquid-solid mixture is transmitted into the mixture settling tank through an inlet which may be at a midlevel of depth within the tank, while the outlet may be located above the inlet, such as near the top of the tank. As the mixture enters the tank, larger particles settle to the bottom where they can be removed, and only the top of the mixture, from which the large particles and other solids have been removed, can flow through the outlet. In some embodiments, the mixture settling tank may optionally include a sieve, which may be located above the inlet, such as at or near the top of the tank, such that the mixture must flow through the sieve to reach the outlet. When flow of the mixture from the source is adequate for the mixture to reach the top of the mixture settling tanks, the mixture may flow through the outlet (or through a plurality of outlets, such as one outlet per centrifuge, depending upon the number of centrifuges and the rate of mixture transmission, for example) and spill over by gravitational force into the outflow pipe or pipes. In some embodiments, the mixture may then flow to a small reservoir, for example, and then to pumps, to provide more steady flow through the system even if the supply of the liquid-solid mixture is intermittent, prior to flowing to the centrifuges.

In some embodiments, the liquid reclamation system includes a single centrifuge which separates the mixture into clean liquid and solid material. In other embodiments, the liquid reclamation system includes two centrifuges which operate in parallel. In still other embodiments, the system includes three centrifuges operating in parallel. As such, the output from the mixture storage tank (or from the strainer or strainers or porous conveyor, if present) can be split to flow to two or three centrifuges. In this way, the flow rate of material through the liquid reclamation system (the amount of mixture that can be processed per unit time) may be increased by using more than one centrifuge. Each centrifuge divides the mixture into a solid component and cleaned liquid. The solid component output may be stored in solid material storage compartment. The clean liquid may be stored in a clean liquid storage tank. Alternatively, the clean liquid may be further processed and/or released into the environment.

In some embodiments, the liquid reclamation system includes a plurality of centrifuges, and the operation of each centrifuge may be manually (by an operator) or automatically selected such that either all or less than all of the centrifuges may be employed at the same time during operation of the system. For example, the liquid reclamation system may include two centrifuges, and either one or both of the centrifuges may be selected to be operational at any time. Alternatively, the system may include three centrifuges, and any one or two or all three of the centrifuges may be selected to operate at one time. For example, in a two centrifuge system, the system may initially operate with one centrifuge functioning as selected by an operator or by the system. During use, if the chosen centrifuge experiences a fault, this centrifuge may stop and the other centrifuge may operate instead. The other centrifuge may take over automatically upon detection of a fault by the system, or at the direction of the operator. Similarly, in a three centrifuge system, two centrifuges may be selected to operate initially, but if a fault is experienced in one of these centrifuges, this centrifuge may cease operating and the third centrifuge may take over operating in its place. Alternatively, the system may allow for an operator to select between the use of all centrifuges at once and the use of less than all of the centrifuges at once, such as one out of two, or one out of three, or two out of three.

A fault that triggers a switch among the centrifuges may be a malfunction in the centrifuge, such as a state of over pressure, over vibration, a problem with spinning, or a hydraulic system fault, for example.

In addition to shutdowns due to faults, a centrifuge may be non-operational for maintenance purposes. The system may be informed of this status of the centrifuge by a signal from the centrifuge so that the system does not initiate operation of the centrifuge.

The centrifuges may be either continuous or batch centrifuges and may be either vertical or horizontal. In some embodiments, the centrifuges are hydraulic. In some embodiments, the centrifuges are vertical and hydraulic. Because the systems are used outdoors, they are exposed to the environment and may become wet or, as in the case of oil fields, sometimes flammable gasses may be present. In such conditions, the use of hydraulic centrifuges may be preferred for enhanced safety.

While horizontal or decanter centrifuges are able to generate a higher g-force than vertical centrifuges and therefore clarify water more quickly, they may not be preferred because they do not handle large particles as well as vertical centrifuges and require more maintenance. Applicants have discovered that vertical centrifuges may be preferable because they are less susceptible to damage during operation, particularly while in motion, such as on a trailer or vehicle.

The solid output of the centrifuges may be substantially dry, such that the majority of the liquid can be reused. The recovered clean liquid may be transmitted from the centrifuges to a clean liquid storage tank. The liquid in the storage tank may be substantially free of solids. For example, the clean liquid may have only particulates about 5 microns or smaller (no particulates greater than about 5 microns). The solid material separated by the centrifuges is released from the centrifuges. In some embodiments, the centrifuges are oriented in a line with a conveyor such as a conveyor belt running beneath them. Separated solids may be dropped from the centrifuges and onto a conveyor which transports them to the solid material storage compartment.

In some embodiments, the system may further process the clean liquid, such as to decrease the pH to a more neutral value, such as a pH of less than about 10 or less than about 9, such as a pH of between about 6 and about 9. This pH adjustment may be desired, or may be legally required, if the cleaned liquid such as cleaned liquid such as cleaned water is to be released into the environment, such as by pumping the water out onto the ground, such as into a ditch beside the road, or near the drilling operations.

The pH of the cleaned recovered liquid may be adjusted by adding an acidifying agent to the liquid, such as hydrochloric acid or aluminum sulfate (which also acts as a flocculent). The acidifying agent can be added to the cleaned liquid after centrifugation, such as in the cleaned liquid storage tank, or can be added to the mixture prior to centrifugation. When added prior to centrifugation, some acidifying agents such as aluminum sulfate can act as flocculants during centrifugation. In other embodiments, carbon dioxide, such as pure carbon dioxide or carbon dioxide from engine exhaust, may be used as the acidifying agent such as by bubbling the carbon dioxide through the cleaned liquid. The cleaned liquid storage tank may include a sensor for monitoring the pH of the cleaned liquid, and the system may control the addition of acidifying agent to the tank in order to maintain the pH in a desired range, such as about 6 to about 10 or about 6 to about 9 or about 6 to about 8.

In some embodiments, engine exhaust is used to acidify the cleaned liquid. The liquid reclamation system may include a gasoline or diesel burning engine, for example, to provide power to the liquid reclamation system. The composition of the engine exhaust may vary, depending upon the type of fuel being burned. However, exhaust will typically include a significant amount of carbon dioxide, such as about 5% to about 15% carbon dioxide. As a result, when the exhaust is bubbled through the clean liquid, the carbon dioxide present in the exhaust may dissolve into the liquid to form carbonic acid, H₂CO₃, thus reducing the pH of the liquid. Exhaust may be transmitted from the engine exhaust outlet through a system of pipes or hoses or ducts to the exhaust bubbler system within the clean liquid storage tank. Because the exhaust is already being produced to operate the system, it provides a convenient and constantly regenerating source of acidification.

Embodiments of the liquid reclamation system which do not include an exhaust bubbler system may connect the engine exhaust outlet to an atmospheric outlet such that the exhaust is released into the atmosphere. However, even in systems which include an exhaust bubbler system, it may not be desirable to use the exhaust bubbler system at all times. For example, it may not be necessary to use the exhaust bubbler system while the liquid is being recirculated for reuse because alkaline liquid may be acceptable for this purpose. Rather it may only be necessary or desirable to use the exhaust bubbler system after reuse of the liquid by the grinding system is complete and prior to disposal of the liquid such as by release into the environment such as into the ground. In order to provide this flexibility of use, a valve may be included in the liquid reclamation system to optionally direct exhaust from the engine to an atmospheric outlet or, when the exhaust bubbler system is being used, to the exhaust bubbler system.

Alternatively, exhaust may be used to acidify a liquid solid mixture, such as a pavement slurry, as a stand-along process (without separating the liquid and solid components of the mixture). For example, exhaust from a machine such as a pavement grinder may be bubbled through the liquid-solid mixture to acidify the mixture such that mixture can be deposited directly into the environment, such as into a roadside ditch or similar location, in compliance with regulations relating to the pH of such materials. In some cases, an exhaust acidification device may be attached to, or may be a component of, the machine which produces the liquid-solid mixture and/or the engine exhaust, such as a pavement grinder. The device may include a tube or chute or other component through which the liquid-solid mixture may continuously flow or it may be contained within the device such as within a tank for a batch type process while the device is in use. In proximity to the tube, chute or tank, such as at the bottom of the tube, chute or tank, may be a second component through which the exhaust may flow, such as a manifold, tubing, or plate having a plurality of perforations or other bubble producing component, through which the exhaust may flow and bubble into the liquid solid mixture, such as at or near the bottom of the liquid or liquid-solid mixture in the tube, chute or tank. The exhaust acidification device may bubble a sufficient quantity of exhaust through the liquid solid mixture to lower the pH of the liquid solid mixture by about 1 pH unit, by about 2 pH units, or by about 3 pH units, for example. After processing by the exhaust acidification device, the liquid-solid mixture may have a pH of less than about 10, or less than about 9, or less than about 8. The exhaust acidification device may include a valve and blower for controlling and directing the exhaust, as described elsewhere in this application.

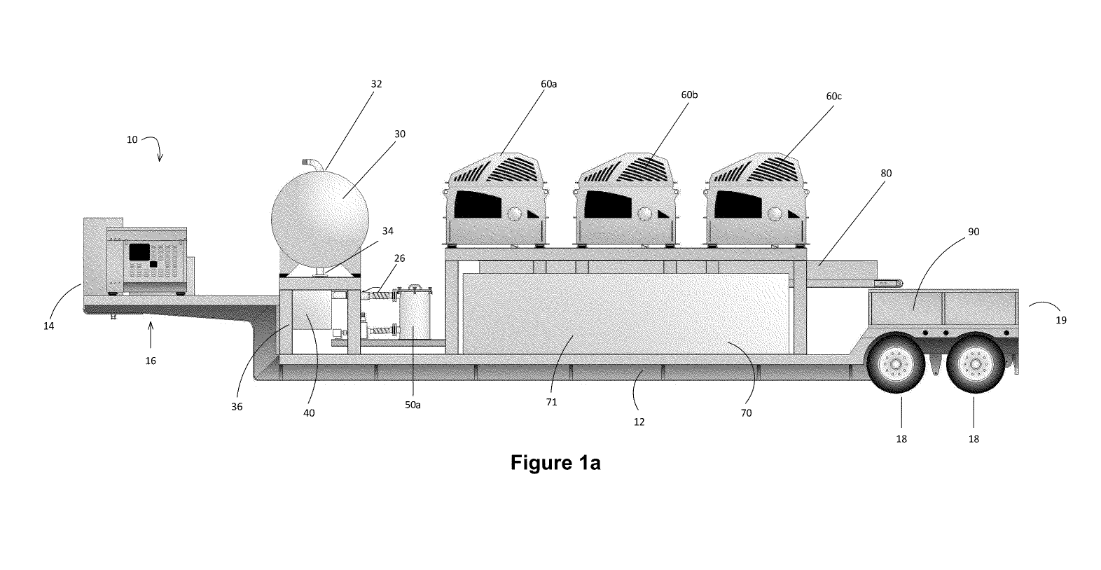

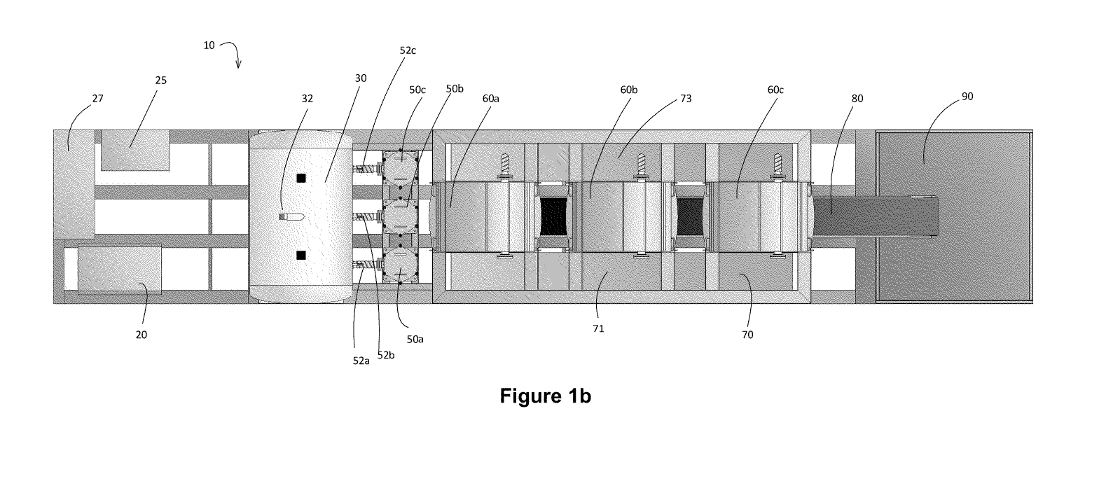

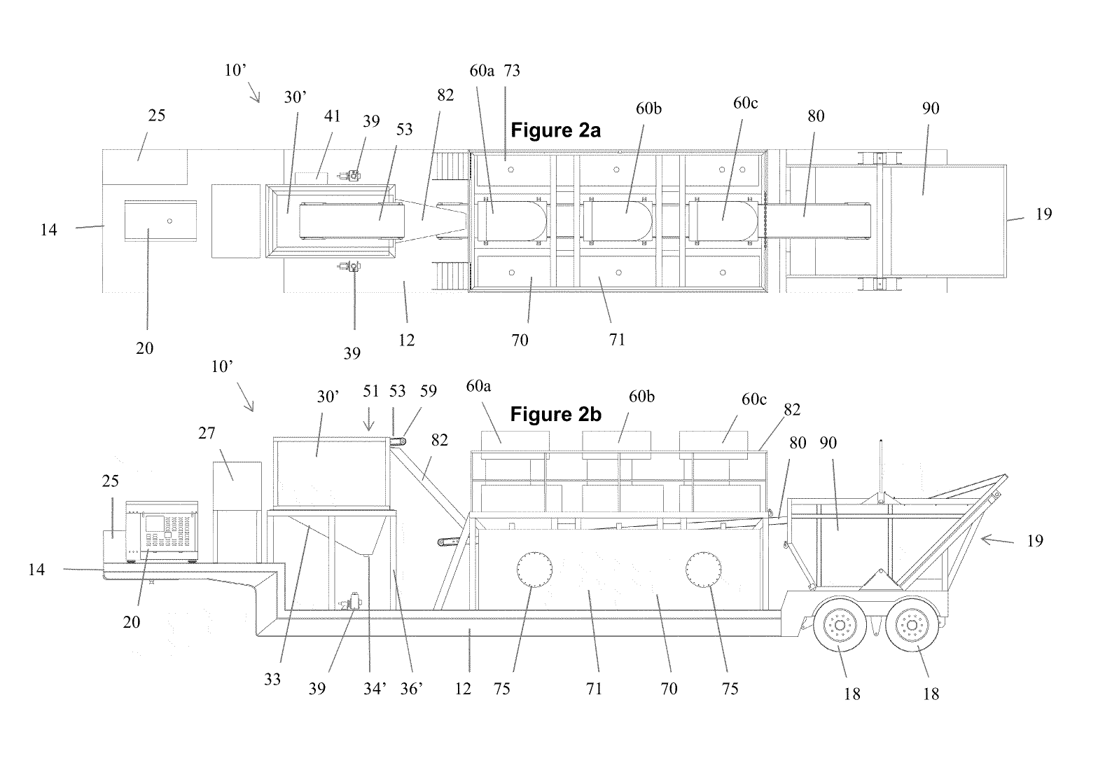

An example of a first liquid recovery system is shown in FIGS. 1a and 1b, and a second liquid recovery system is shown in FIGS. 2a and 2b. In these embodiments, the liquid recovery system 10, 10′ is provided on a wheeled trailer, though the system 10, 10′ could alternatively be self-propelled, or may be stationary. The system 10, 10′ includes a platform 12 upon which the functional components of the system 10, 10′ are supported. The platform 12 is elongated, having a narrower width than length so that the system 10, 10′ can be accommodated within a standard traffic lane. For example, the system 10, 10′ may be between about 7.5 and about 8.5 feet wide. In order to include all of the necessary components, the system 10, 10′ may be between about 15 and about 48 feet long. For example, embodiments including only a single centrifuge 60 may be about 15 to about 20 feet long. Embodiments including two centrifuges 60 may be about 20 to about 30 feet long, and embodiments including three centrifuges 60 may be about 30 to about 48 feet long. While it is desirable for the system 10, 10′ to be accommodated within a standard traffic lane, for some applications, such as in non-road applications, a wider platform may be employed.

A first end 14 or front end of the system 10, 10′ attaches to a motorized vehicle such as a pavement grinder or a semi cab. As such, the first end 14 may include a king pin or other form of or configuration for attachment and may include a stepped up portion 16 as shown to allow for this connection. The remainder of the platform 12 is horizontal and close to the ground to provide a maximum amount of useful space above the platform 12. A plurality of wheels 18, such as 4 or 8 or 12 wheels 18, are attached to the underside of the platform 12 at the second end 19 or back end of the system 10, 10′ to support the back of the system 10, 10′, while the front of the system 10, 10′ is supported by the connection to the pulling vehicle in mobile embodiments such as these. If additional support is required, additional wheels 18 may be provided at other appropriate positions along platform 12.

Above the stepped up portion 16 of the platform 12, at the front end 12 of the system 10, 10′, is an engine 20, which could operate on diesel, gasoline, natural gas, ethanol, or other fuel source. The engine 20 is connected to a gear box and hydraulic pumps (not shown). Also at the front end 14 of the system 10, 10′ are a fuel tank 25 for supplying fuel (such as diesel fuel) to the engine 20 and a hydraulic fluid reservoir 27. The locations of these components at the front end 12 vary between system 10 and system 10′, and other locations are also possible. The engine 20 powers the hydraulic pumps and is connected through the gears in the gear box. Hydraulic fluid is supplied by the hydraulic pumps through a system of hydraulic tubes, pipes and/or hoses to each of the components which operate hydraulically. These hydraulic components may include one or more of the centrifuges 60, slurry pumps, water pump, and agitators. In some embodiments, a single open loop pump, such as a 100 p pump, feeds a valve bank with a plurality of valves. Each valve may control a different component including the liquid pump, the mixture pumps, the conveyors, the agitators, the blowers, and the centrifuge gates. In addition, each of the centrifuges may include its own hydraulic pump to operate the motor to spin the centrifuge bowl, and this pump may be hydrostatic rather than open loop. All valves may be operated with 12V DC, and the pumps for the centrifuge bowls may be controlled with a variable DC signal which is proportional to the displacement of the pump with no AC power used in the system. This allows for accurate control over the centrifuge speed, whether or not it is used with a closed loop controller. Also, the hydraulic system that controls the centrifuge may be open loop or closed loop. However, a closed loop system may be preferred since it may be more efficient and may add to the ability of the centrifuge to have dynamic breaking, which can be used to slow the centrifuge in a very controlled manner.

In system 10 of FIGS. 1a and 1b, mixture tank 30 is provided on a central portion of platform 12 at a point behind end 14 spaced away from engine 20. In the embodiment shown, the mixture tank 30 is cylindrical and extends across the width of the platform 12. It includes an input 32 on the top of the tank 30, through which the mixture may be pumped into mixture tank 30 after recovery or production at its source such as from the roadway by the pavement grinder, from a drilling fluid pit, or from a septic tank. On the underside of the mixture tank 30 is an outlet 34 through which the mixture passes when the liquid reclamation system 10 is operating. The mixture tank 30 is located directly above, and is supported by, a support 36 which functions as a base for the mixture tank 30 and which can also house the operational controls 40 of the system.

Behind the support 36 are three strainers 50a, 50b and 50c, which are located side by side on the platform 12. Pipes connect the mixture tank outlet 34 to the strainer inputs 52a, 52b and 52c. Within the strainers 50a, 50b and 50c large solids such as cuttings and roadway debris are removed from the mixture prior to centrifugation, as described previously, in order to decrease the wear or damage to the centrifuges. Strainer outputs connect the strainers 50a, 50b and 50c to the centrifuges 60 by pipes and pumps (not shown) to convey the mixture from the strainers 50a, 50b, 50c to the centrifuges 60a, 60b, 60c.

In the alternative embodiment shown in FIGS. 2a and 2b, the liquid-solid mixture is pumped from its source, such as a pavement grinder or other source through input tube 35 onto conveyor system 51. Input tube 35 extends over the mixture tank 30′ and above and across the width of porous conveyor belt 53. Input tube 35 includes a horizontal aperture (not shown) extending along it lower surface over the conveyor belt 53 and having a length slightly less than that the width of the conveyor. The liquid-solid mixture therefore is pumped out of the input tube 35 through the aperture and falls onto the porous conveyor belt 53 such that the liquid-solid mixture must pass through the porous conveyor belt 53 to enter the mixture tank 30′. The conveyor belt 53 is sufficiently porous such that the liquid-solid mixture flows through the pores in the belt 53 and into the open top of the mixture tank 30′. Large solid components are trapped by the conveyor belt 53 (as be the sieve described above) and conveyed to chute 82, on which they slide downward and are then deposited onto conveyor 80 and transmitted to solids hopper 90.

The liquid-solid mixture tank 30′ includes a bottom surface 33 that slopes downward toward outlet 34′. This sloping may be useful for assisting the flow of the liquid-solid mixture toward the outlet 34′ particularly when the liquid-solid mixture is thick. The mixture tank 30′ is supported by support 36′. The liquid-solid mixture flows from the outlet 34 to the centrifuges 60a, 60b, and 60c through pipes or tubes (not shown) under the control of pumps 39 without passing through sieves, though in some embodiments sieves like those in FIGS. 1a and 1b may also be used. In this embodiment, there are three pumps 39, one for each centrifuge 60a, 60b, and 60c, though only two pumps 39 can be seen in FIGS. 2a and 2b.

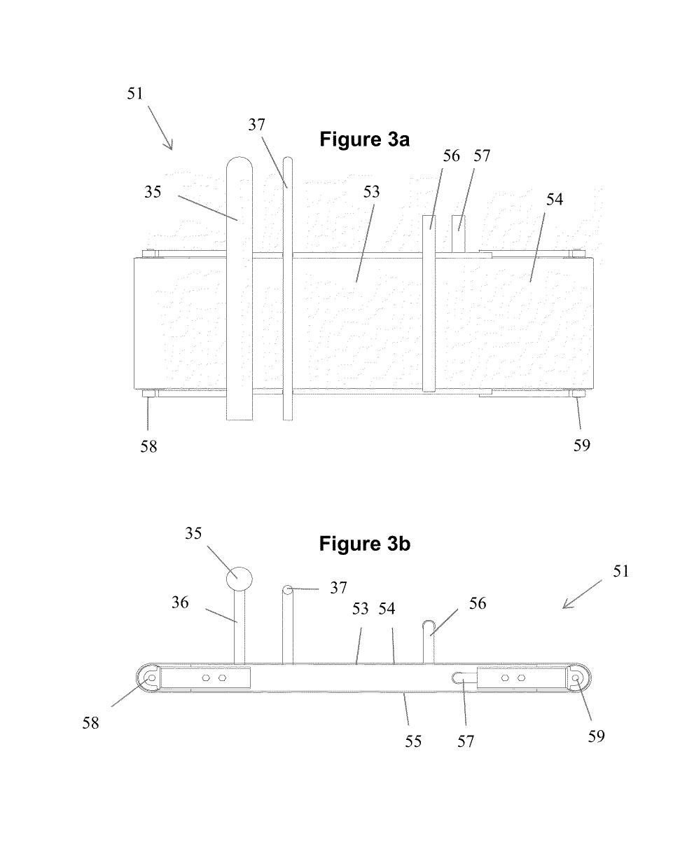

A more detailed view of a conveyor system 51 which may be used in various embodiments, such as the embodiment of FIGS. 2a and 2b, is shown in FIGS. 3a and 3b. The porous conveyor belt 53 forms a loop and include a top portion 54 and bottom portion 55, though the portions of the belt 53 which form top and bottom portions 54, 55 continually change as the belt 53 rotates around rear roller 59 and front roller 58. One or both of the rollers 58, 59, such as the rear roller 59, may drive the belt, such as through a motor such as a hydraulic motor (not shown). The input tube 35 is also shown, positioned above the conveyor belt 53 near the front end of the belt 53 by support 36. A clean liquid return 37 is also shown which extends across the conveyor belt 53 and includes one or more apertures to deliver cleaned fluid, such as cleaned fluid recycled by the system 10′ from the clean water tank 70 onto the conveyor belt 53. This may be done to clean the system 10′, for example.

Also included in this embodiment are upper blower 56, extending across the width of top portion 54 of the conveyor belt 53 and directing air downward toward the conveyor belt 53, such as straight down, in order to assist the flow of the liquid-solid mixture through the belt 53 and to remove liquid solid mixture from large solid pieces that may be trapped on the belt 53. A lower blower 57 is also shown, extending across the width of the conveyor belt 53 between the upper portion 54 and the lower portion and directing air downward through the lower portion 55 from inside the loop of the belt 53. The air may be directed straight down or at an angle, such as angled rearward (against the direction of movement of the lower portion 55) at a 45 degree angle, for example, relative to the lower portion 55 and may function to help dislodge solid material that may be trapped in the pores of the belt 53 and blow them downward and/or rearward so that the liquid-solid mixture can continue to flow through the pores of the belt 53. In FIG. 2b it can be seen that the rearward most end of the conveyor belt 53 extends over the forwardmost aspect of the chute 82. This allows the material that is conveyed by the belt 53 to be deposited onto the chute 82 to then slide away under the force of gravity. The lower blower 57 may be located within the portion of the conveyor belt 53 that overlies the forwardmost part of the chute 82, such that solid material that is blown out of the pores of the lower portion 55 of the belt 53 is blown onto chute 82 to slide away with the excluded solids.

In the embodiments shown in FIGS. 1a and 1b and FIGS. 2a and 2b, within the support 36 are the operational controls 40 of the system 10, 10′ including a processor in electrical communication with some or all components of the system 10. On an outer surface of the support 36, a control panel 41 can be provided as a user interface in electrical communication with the operational controls 40 which allows an operator to interface with the operational controls 40 of the system 10, 10′. The operational controls 40 include software to operate and to monitor the system 10, 10′ and can continuously monitor safety parameters such as fluid levels in the tanks and centrifuge functioning. The operational controls 40 may be able to shut down the entire system 10, 10′, or individual centrifuges 60, when a problem is detected, depending upon the severity of the problem. In addition, the operational controls 40 can monitor the liquid levels at the source, such as the water onboard the pavement grinder with which the liquid reclamation system 10 is being used, to keep the fluid at the desired level, such as to keep the grinder's water tank full so that maximum ballast can be maintained by the pavement grinder. In embodiments such as the system 10′ shown in FIGS. 2a and 2b, operational controls may also control functions such as the speed of rotation of the conveyor belt 53 and of the air output by the blowers 56, 57, for example, to adjust for different rates of input of the liquid-solid mixture into the system 10′.

The control panel 41 (not seen on FIGS. 1a and 1b but located on the control housing 36) may include a visual display, a keypad, a touch screen, and/or other types of user interfaces, for example. In the embodiment shown, the system 10 may be controlled using the control panel 41 and/or using a remote controller. The remote controller may be electrically connected to the operational controls or may send and receive signals via infrared, radio (RF) or other form of transmitted energy signal to function as a user interface like the control panel. Using the user interface (control panel 41 or remote control) a user can activate the system 10, 10′, select one or more centrifuges 60 for operation, input operation details (such as time and speed), and receive data (such as fluid levels in the mixture tank 30, 30′ and the cleaned liquid tank 70, pH of the cleaned liquid, liquid level at the source such as in the grinder water tank, and operational parameters of the engine).

Three centrifuges 60a, 60b and 60c are located in a row from front to back behind the strainers 50a, 50b, and 50c or conveyor 51. In other embodiments, the system 10, 10′ may include fewer centrifuges 60 or additional centrifuges 60. Strained and/or filtered mixture can flow through pipes into each of the centrifuges 60a, 60b, 60c or, in alternative embodiments, serially from one centrifuge to a subsequent centrifuge. However, operational controls 40 may control the flow such that the mixture does not flow to one or more of the centrifuges 60a, 60b, 60c by controlling a valve and/or by turning the centrifuges on and off. After centrifugation, cleaned liquid flows through liquid outlets 64 and through pipes into the clean liquid tank 70. The solid components removed by the centrifuges 60a, 60b, 60c exit through centrifuge solids outlets and drop onto a conveyor 80.

Directly beneath the centrifuges 60a, 60b, 60c is the cleaned liquid tank housing, which supports the centrifuges, 60a, 60b, 60c and inside which the cleaned liquid tank 70 fits. By locating the cleaned liquid tank 70 beneath the centrifuges 60a, 60b and 60c, the cleaned liquid tank 70 occupies a large space and is therefore able to store a large volume of liquid.

In the embodiment shown, the cleaned liquid tank 70 is bifurcated and includes a first tank 71 and a second tank 73 in fluid communication with each other. Each of the first tank 71 and the second tank 73 are located side by side and extend along the length of tank 70 beneath each of the centrifuges 60a, 60b, 60c, with conveyor 80 running between them. In FIG. 2b, cleanout ports 75 are also shown. The first tank 71 into which liquid passes directly from the centrifuges 60a, 60b, 60c may include a pH monitor and/or a pH reduction component such as an exhaust bubbler system 100. The second tank 73, into which liquid flows from the first tank 71, may include a cooling component to decrease the temperature of the cleaned liquid. For example, the cooling component may be a cooling coil within the tank 73 which may include a compressed coolant. The cooling component may decrease the temperature of the cleaned liquid to about 100° F., such as to about 70-100° F., or to less than about 90° F., such as to about 80-90° F., for example. In the embodiment shown, the bifurcation of tank 70 is incomplete such that cleaned liquid flows freely from the first tank 71 to the second tank 73. Alternatively, the cleaned liquid tank 70 could be a single tank including a pH monitor, a pH reduction component and a cooling component. However, the applicant has discovered that separating these pH reduction components and the cooling components allows for increased efficiency, as pH reduction was found to be more efficient at higher temperatures. Therefore, in preferred embodiments, the pH reduction component is located upstream prior to and separate from the cooling component.

Conveyor 80 is a conveyor belt which transports the solid component, sometimes referred to as cake in the case of pavement slurry, from the centrifuges 60a, 60b and 60c, to the solids hopper 90 which is a storage container at the back end 19 of the system 10, 10′. In some embodiments, the solids hopper 90 is removable so that it can be removed and replaced by an empty hopper 90 when full. In other embodiments, the solids hopper 90 can pivot up so as to dump the solids into a dump truck or dump trailer, for example. Alternatively, a conventional conveyor or auger can be used to offload the solids from the hopper 90 to a dump truck or dump trailer, for example.

The system 10, 10′ may also include walkways, stairs, and/or guardrails, such as guardrails 82 in FIG. 2b. The walkways may be located around the periphery of the system 10, 10′ to provide access to the system components.

In some embodiments, the system 10, 10′ is all hydraulic as described above and under 12V DC operation. In such embodiments, there would be no high voltage, making the system safer to use in a wet environment and/or when flammable gases and or fluids are present.

Embodiments of the invention can obtain cleaned liquid without the use of chemicals. The design of the system 10, 10′ allows it to be used without the addition of anti-foaming agents, flocculent, or pH reducers. However, in some embodiments, or when used with certain types of mixture, the use of additional agents may be desirable. For example, certain pavements such as newly surfaced roadways may be coated with a sealant sometimes referred to as cure. Such sealants may be water-based, in which case their presence in cleaned water may be irrelevant or may cause a reduction in water clarity. Other sealants may be oil-based. Such sealants may be removed from the water by an extended centrifugation time and/or by use of an oil skimmer in the cleaned water tank 70. For example, the oil skimmer may be a belt, drum, disk, mop or tube which passes through the cleaned water and removes the oil from the cleaned water. The oil can then be removed from the oil skimmer by wiper blades or a pinch roller, for example. In other embodiments, the oil skimmer may be a floating suction member that removes the oil by suction.

Embodiments of the invention are also highly efficient. For example, a two centrifuge system is able to process the slurry produced by a grinder traveling at 40 feet per minute and having an average pavement removal depth of ¼ inch at the speed at which the slurry is produced. A three centrifuge system is able to process the slurry produced by a grinder traveling at 40 feet per minute and having an average depth of pavement removal of ⅜ inch at the speed at which the slurry is produced. As such, the system 10, 10′ is able to travel along with the grinding systems, continuously recycling the water and returning the cleaned water to the grinders, as the grinders move along the pavement. This allows the pavement grinders to continue grinding pavement without stopping work to travel to another location to unload dirty water and reload clean water.

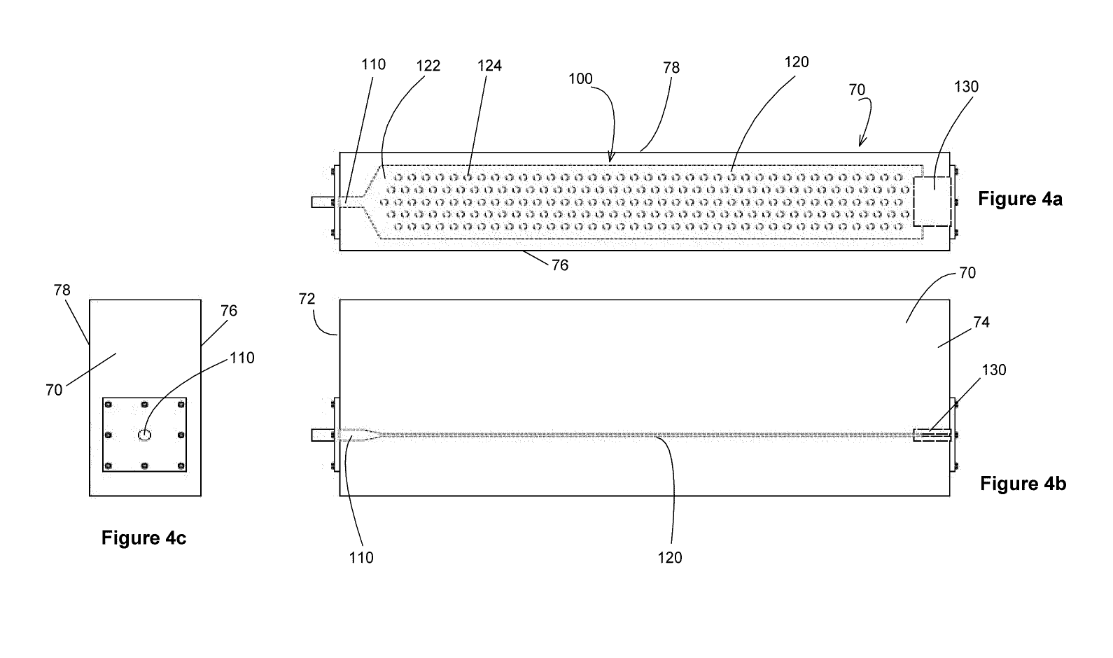

An example of an exhaust bubbler system which may be used in embodiments of the invention is shown in FIGS. 4a, 4b, and 4c. FIG. 4a shows a top view of the exhaust bubbler system 100, while FIGS. 4b and 4c respectively show side and end views of the exhaust bubbler system 100. The exhaust bubbler system 100 is shown submerged within a cleaned liquid storage tank 70. In other embodiments, the exhaust bubbler system could be located elsewhere in the liquid reclamation system 10, 10′, such as in the mixture tank 30 or could be separate from the liquid reclamation system 10, 10′, such as a stand-alone device or a component of a vehicle, for example. The system 100 includes an exhaust inlet 110 and a bubbler plate 120 and can also include additional fixation components 130. In the embodiment shown, the bubbler system 100 extends across the tank 70, from the tank front end 72 to the tank back end 74, and is attached to the tank at each of its front and back ends 72, 74 to secure the system 100 within the tank 70.

The plate 120 is elongated and planar, having an upper planar surface 122 with a plurality of small apertures 124, a lower surface, and a gap or passage between the upper and lower surfaces for the flow of exhaust from the inlet 110 to the apertures 122. Exhaust enters the system 100 through the inlet 110, passes into the plate 120 and exits the plate 120 through the apertures 124 as small bubbles. The apertures 124 can therefore be sized to create bubbles of the desired size to obtain the necessary reduction of pH. For example, the apertures may be between about 1/16 inch and ½ inch in diameter, or between about ⅛ inch and ⅜ inch in diameter. In some embodiments, the apertures 124 are located across and generally evenly dispersed over the entire upper surface 122 of the plate 120. Any suitable device known to those skilled in the art to be capable of making a plurality of small bubbles may be used for bubbler system 100. In some embodiments, the exhaust within the plate 120 may be pressurized to reduce back pressure on the engine.

It can further be seen that the plate 120 is shaped to extend across nearly the entire horizontal cross section of the tank 70, from front end 72 to back end 74 and from side wall 76 to side wall 78 of the tank 70, with only a small gap between the plate 120 and the tank walls 72, 74, 76 and 78. In some embodiments, such as those in which the plate 120 is located above the bottom of the tank 70, the gap around the plate provides space for liquid circulation. In other embodiments, the plate 120 may be located substantially at the bottom of the tank 70 and may or may not include a gap between the plate 120 and tank walls 72, 74, 76 and 78.

It is generally desirable to place the bubbler system 100 deep within the tank 70, so that the bubbles pass through a sufficient amount of clean liquid as they float upward from the bubble plate 120 to the top of the cleaned water in the tank 70 and then out into the atmosphere. By passing through a sufficient depth of the liquid, the exposure or residence time and contact between the bubbles and the liquid is increased, so that a sufficient pH reduction can occur. However, the presence of an exhaust bubbler system 100 in flow communication with the engine exhaust outlet can create some back pressure on the engine 20. Furthermore, the amount of this back pressure depends upon the depth of placement of the exhaust bubbler system 100 within the tank 70. That is, the deeper the bubbler system 100 is located, the greater the amount of back pressure to which the engine 20 is subjected. It may therefore be preferable to place the bubbler system somewhere above the bottom of the tank 70, but still at a sufficient depth for adequate pH reduction to occur.

In the embodiment shown, it can be seen in FIGS. 4b and 4c that the bubbler plate 120 is located at a distance of approximately one third of the full water depth of the tank above the bottom of the tank 70 (with the surface of the water being near the top of the tank 70 when the tank 70 is full). At this location, it places less back pressure upon the engine 20, while still being at a sufficient depth to expose the liquid to the bubbles for an amount of time necessary to reduce the pH by the desired amount. In some embodiments, the bubbler plate 120 may be located between approximately the bottom of the tank 70 and a location at approximately one half of the full water depth of the tank 70 above the bottom of the tank 70. For example, the bubbler plate 120 may be located at a depth such that the pressure drop created by the bubbler system 100 is less than about 100 in/H₂0, such as between about 60 in/H₂0 and about 80 in/H₂0. In other embodiments, the bubbler plate 120 may be located at a depth such that the pressure drop created by the bubbler system is less than about 50 in/H₂0, such as between about 35 in/H₂0 and 45 in/H₂0.

The bubbler system 100 is preferably located at a sufficient depth below the surface of the liquid such that the exhaust bubbles will reduce the pH by the desired amount, e.g. to reduce the pH to a regulatory required level for release of the liquid into the environment. For example, in some embodiments, the bubbler system 100 is located at a depth of at least about 100 inches beneath the surface of the cleaned liquid when the tank 70 is full, such as between about 60 and 80 inches. In other embodiments, the bubbler system 100 is located at a depth of at least about 50 inches beneath the surface of the cleaned liquid when the tank 70 is full, such as between about 35 and 45 inches.

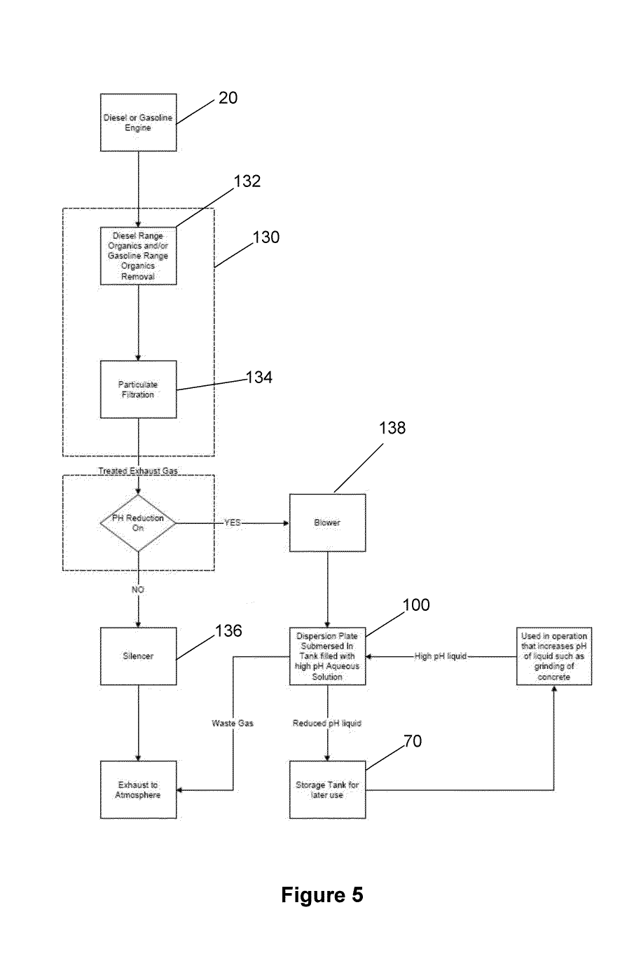

Liquid reclamation systems 10 which include exhaust bubbler systems 100 may further include a blower 138 (see FIG. 5) located between the exhaust outlet from the engine 20 and bubbler system inlet 110. In some embodiments, the blower 138 is located between the exhaust redirection valve and the bubbler system inlet 110. In such embodiments, the blower 138 may be used to reduce the back pressure placed upon the engine 20 by the bubbler system 100. In embodiments which include a valve for redirecting the exhaust, the blower 138 may only be engaged when exhaust is directed through the bubbler system 100 and may be off when exhaust is vented through the atmospheric outlet.

Because engine exhaust includes additional components besides oxygen and carbon dioxide and these additional components could be transmitted to the liquid during use of the exhaust bubbler system 100, it may be desirable to remove these additional components from the exhaust prior to passing the exhaust through the exhaust bubbler system 100. Some embodiments therefore include an exhaust cleaning unit for the reduction of these additional exhaust components. The exhaust cleaning unit may be located in close proximity to the engine, such as on top of or along side of the engine, but other locations are also feasible.

The exhaust cleaning unit may remove or reduce the levels one or more components from the exhaust, including contaminants such as carbon monoxide, hydrocarbons and/or particulate matter. Appropriate exhaust cleaning units are commercially available, such as the CleanAIR ASSURE DOC™ system (diesel engine converter system) and the CleanAIR PERMIT™ Filter System, both sold by CleanAIR SYSTEMS. The level of contaminant reduction needed will depend upon the type of exhaust cleaning unit used as well as the type of fuel used by the engine 20. In some embodiments, it may be preferable to use low sulfur fuel to minimize the level of contaminants. In some embodiments, carbon monoxide and/or hydrocarbons present in the exhaust are reduced by about 50% or more, such as about 75% or more, or about 90% or more. In some embodiments, particulate matter present in the exhaust is reduced by about 10% or more, such as about 15% or more. In other embodiments, the particulate matter present in the exhaust is reduced by about 50% or more, such as about 70% or more or about 80% or more.

The exhaust cleaning unit includes an exhaust inlet and an exhaust outlet. Between the inlet and the outlet, the exhaust passes through the cleaning components of the unit, and these components may vary depending upon the type of unit used. In some embodiments, the unit includes a catalyst such as an oxidation catalyst which may be located on a filter, such as a wall flow filter within the unit. As the exhaust passes over the wall and/or through apertures in the wall of the cleaning unit, it reacts with the catalyst and the contaminants are removed. The cleaning unit may further include sensors for detecting backpressure and temperature, for example, and a microprocessor which may monitor and log the functioning of the unit, including data such as the time of operation, backpressure, and temperature. This data can be transmitted to the operational controls 40. The cleaning unit may further include a muffler, or a muffler may be provided separately in close proximity to the engine 20, such as on top of the engine 20.

A similar system could be used as a stand-alone device or as a component of a different system or a vehicle component. The device may include the same or similar components. In some embodiments, rather than reducing the pH of a liquid or liquid-solid mixture within a tank, the exhaust bubbler system may allow for continuous flow of the liquid or liquid-solid mixture, such as by using a tube or other similar component in place of the tank, or having inlets and outlets in the tank that allow for continuous flow. The liquid or liquid-solid mixture flowing through the tube or tank may pass continuously over the bubbler plate or similar bubble producing component in the same way as described above. In some embodiments, the pH reduction system may be used with, or may be a component of, a pavement grinding vehicle and may bubble exhaust produced by the vehicle engine through the slurry, such as continuously as it is produced. The slurry having lowered pH may then be in compliance with environmental regulations such that it can disposed of directly onto the ground such as onto the road side.

A schematic diagram of an exemplary system to reduce the pH of cleaned liquid is shown in FIG. 5. Exhaust is produced by a diesel or gas engine 20 and passes to an exhaust cleaning unit 130 which produces treated exhaust having reduced levels of organics and particulates. The exhaust cleaning unit 130 includes an organics removal component 132 and a particulate filtration component 134, which may be two separate components or may be a single component which performs both functions. In some embodiments, the pH reduction may be either activated or not, and the exhaust flow may be redirected accordingly. In other embodiments, the pH reduction is always activated, and no exhaust flow redirection is possible. When the pH reduction system is activated, the treated exhaust the flows through an optional blower 120 and then into the exhaust bubbler system 100. The exhaust is bubbled through the cleaned liquid having a high pH in order to reduce the pH to a more neutral value, and is then released into the atmosphere. In embodiments in which the exhaust bubbler system 100 can be deactivated, after treatment by the exhaust cleaning unit 130, when the exhaust bubbler system 100 is not activated, the exhaust can pass through a silencer 136 and then vent to the atmosphere. The cleaned and neutralized liquid can then be discarded, stored for later use in the cleaned liquid storage tank 70, or reused in further operations. If reused in further operations, such as further pavement grinding or further drilling, the mixture produced by those operations using the recycled liquid can then be returned to the liquid reclamation system 10, 10′ where the liquid can again be recovered, the pH optimally reduced, and the liquid can be reused again. In this way, the liquid can be repeatedly and continuously recycled for use in operations.

The cleaned liquid that is recovered from the liquid-solid mixture may be returned to the operations in which it is used. In this way, the operations are able to continue without the need to stop to replenish the liquid. As such, the liquid reclamation system 10 allows for longer uninterrupted operation. In addition, the operations may consume less liquid because the liquid is continuously recycled, with only small amounts of additional liquid needing to be added during operations. In this way, the liquid reclamation system 10, 10′ provides a benefit to the environment by conserving and recycling liquids such as water. Finally, embodiments which adjust the pH of the liquid or liquid-water mixturer provide further environmental benefits by returning the recovered liquid such as water or the liquid-solid mixture such as the slurry to a more neutral pH, and thus a pH which has less environmental impact when released.

### EXPERIMENTAL

Water was recovered using a prototype water recycling system as described herein including a diesel engine, a centrifuge, a slurry storage tank, a dry material storage container, and an exhaust bubbler system, but without an exhaust cleaning unit, all mounted on a trailer.

First, pavement was ground using a Cushion Cut PC5000 grinder. The slurry recovered by the pavement grinding system was conveyed to the water recycling system. The water was then processed through the recycling system.

Water was sampled and tested at various points in the process and the results are shown in Table 1 below. Sample 1 was taken prior to any use by the pavement grinding system. Samples 2 and 3 were taken after use in pavement grinding and recovery from two different locations within the slurry tank. Sample 4 was taken from the water after 5 minutes of centrifugation of the slurry. Sample 5 was taken from the water in the cleaned water tank after allowing it to naturally settle for one day without centrifugation or pH reduction. Sample 6 was water that was not centrifuged but was treated by an exhaust bubbler system. The pH was tested according to SM 4500-H+B. The total dissolved solids were measured according to SM2540C and the total dissolved solids were measured according to SM25400D.

TABLE 1

| | | total dissolved | Total suspended |
|---|---|---|---|
| Sample | pH | solids (mg/L) | solids (mg/L) |
| 1 | 8.3 | 310 | 224 |
| 2 | 12.3 | 12500 | 2320 |
| 3 | 12.4 | 19200 | 2900 |
| 4 | 12.3 | 1160 | 1980 |
| 5 | 12.3 | 64.1 | 1860 |
| 6 | 9.0 | 929 | 1000 |

It can be seen in sample 2 that after use in pavement grinding the water became highly basic and acquired a large amount of dissolved and suspended solids. Following partial centrifugation in samples 3 and 4, the total and suspended solids decreased. Sample 5 had reduced solids after settling but was highly basic. Following treatment with the exhaust bubbler system, the pH of the water in Sample 6 decreased to 9.0 in approximately 45 minutes, showing that it was successful at reducing the pH to a level at which it may be disposed of without the need for further pH adjustment. It is unknown why the total suspended solids decreased and the total dissolved solids increased in Sample 6 but it is hypothesized that the carbonic acid created by the exhaust may have reacted with a portion of the suspended solids, causing them to dissolve.

An additional sample of water was obtained after passing through the prototype water recycling system and exhaust treatment system (without an exhaust cleaning unit) as described above with regard to sample 6. This sample was tested for the presence of other contaminants in the water and the results are shown in table 2 below. Total organic carbon (TOC) was measured according to SM 5310C. Sulfur was measured according to EPA 6010. Oil and grease were measured according to EPA 1664 OG. Diesel range organics were measured according to WI MOD DRO.

TABLE 2

| | |
|---|---|
| Total Organic Carbon | 75.9 |
| (mg/L) | |
| Sulfur (mg/L) | 2450 |
| Oil and Grease | Non detected |
| Diesel Range Organics | 11.3 |
| (mg/L) | |

The results in table 2 demonstrate that some amount of contamination may pass from the exhaust produced by diesel fuel and into water when an exhaust bubbler system is used. It may therefore be desirable to use an exhaust cleaning unit to reduce the level of contaminants in the exhaust and/or to use a fuel which produces a cleaner exhaust.

Various examples have been described. These and other examples are within the scope of the following claims.

1. A liquid recovery system comprising:
a platform having a plurality of wheels;
a liquid-solid mixture storage tank or settling tank;
a centrifuge in flow communication with the storage tank or settling tank;
a solids storage component;
a cleaned liquid storage tank in flow communication with the centrifuge.

2. The system of claim 1 wherein the system includes a storage tank, the system further comprising a strainer, wherein the liquid-solid mixture first passes through the strainer and then passes into the centrifuge.

3. The system of claim 1 wherein the system further includes a porous conveyor belt positioned directly above the storage tank and/or settling tank.

4. The system of claim 3 comprising an upper air blower directed at a top portion of porous conveyor belt and a lower air blower directed at a bottom portion of the porous conveyor belt.

5. The system of claim 4 wherein the air blowers comprise air knives.

6. The system of claim 1 wherein the centrifuge is hydraulic.

7. A liquid recovery system comprising:
a liquid-solid mixture storage tank having an open top or a settling tank having an open top;
a porous conveyor belt directly above the open top of the storage tank or the settling tank;
a mixture inlet tube located directly above the porous conveyor, wherein the inlet tube is configured such that when a mixture is supplied to the system through the inlet tube, the mixture passes through the porous conveyor to fall into the storage tank or settle tank;
an air blower directed at an upper portion of the conveyor belt;
a centrifuge in flow communication with the storage tank or settling tank;
a solids storage component; and
a cleaned liquid storage tank in flow communication with the centrifuge.

8. The liquid recovery system of claim 7 further comprising an air blowers directed at the lower portion of the conveyor belt.

9. The liquid recovery system of claim 7 further comprising:
an engine which produces exhaust; and
an exhaust bubbler within the cleaned liquid storage tank, wherein the exhaust bubbler is configured to receive the exhaust from the engine and release the exhaust through a plurality of apertures as bubbles when the cleaned liquid storage tank contains cleaned liquid.

10. The liquid recovery system of claim 7 wherein the bubbles produced by the exhaust bubbler are sufficient to reduce the pH of the cleaned water to less than about 9.0.

11. The liquid recovery system of claim 8 wherein the exhaust bubbler comprises an exhaust inlet and a bubbler plate, wherein the bubbler plate is a horizontally oriented and wherein the plurality of apertures are located on the upper surface of the plate.

12. The liquid recovery system of claim 7 further comprising a blower located in exhaust flow communication between an exhaust outlet of the engine and the exhaust bubbler.

13. The liquid recovery system of claim 10 further comprising an exhaust cleaning unit in flow communication between the engine exhaust outlet and the exhaust bubbler, wherein the exhaust cleaning unit reduces the amount of hydrocarbons in the exhaust.

14. A method of recycling liquid from a liquid-solid mixture comprising:
pumping the mixture into a storage tank or settling tank,
centrifuging the mixture to separate a solid component from a cleaned liquid component;
transmitting the cleaned liquid component from the centrifuge to a cleaned liquid tank; and
transmitting the solid component to a solids storage component;
wherein each of the storage tank, the centrifuge, the cleaned liquid tank, and the solids storage component are components of a mobile liquid reclamation system.

15. The method of claim 13 wherein the liquid component comprises drilling fluid and the solid component comprises cuttings.

16. The method of claim 13 further comprising reducing the pH of the cleaned liquid within the cleaned liquid tank.

17. The method of claim 15 wherein the mobile liquid reclamation system further comprises an engine which produces exhaust, wherein reducing the pH of the cleaned liquid comprises bubbling the exhaust through the cleaned liquid.

18. The method of claim 13 wherein the mixture comprises septage.

19. The method of claim 13 further comprising pumping the mixture into the storage tank or settling tank comprises pumping the mixture onto a porous conveyor belt directly above the storage tank or settling tanks and allowing the mixture to flow through pores of the porous conveyor, further comprising separating out and conveying away a portion of the solid component on the conveyor belt prior to centrifuging the remaining mixture.

20. The method of claim 19 further comprising blowing air onto the mixture on the porous conveyor belt.

21. A method of reducing a pH of a liquid or a liquid-solid mixture comprising:
passing the liquid or liquid-solid mixture through a pH reducing device, the device comprising:
a first component for holding the liquid or liquid-solid mixture, wherein the first component may be configured such that the liquid or the liquid-solid mixture may continuously flow through the first component or may remain contained within the first component when the device is in use; and
a second component through which engine exhaust passes in proximity to the first component;
wherein the device is configured to inject the engine exhaust from the second component into the first component at or near a bottom of the first component;
passing engine exhaust through the second component; and
bubbling the exhaust through the liquid or liquid-solid mixture.

22. The method of claim 21 wherein the liquid or liquid-solid mixture comprises pavement slurry and wherein the pH reducing device is configured for attachment to a pavement grinder.
